(19) United States
(12) Patent Application Publication
(10) Pub. No.: US 2008/0178564 A1
(43) Pub. Date: Jul. 31, 2008

(54) EQUESTRIAN PAD

(76) Inventor: Marjean McIntyre, Eagle, NE (US)

Correspondence Address: HUSCH BLACKWELL SANDERS LLP, 4801 Main Street, Suite 1000, KANSAS CITY, MO, 64112, US

(21) Appl. No.: 11/951,159

(22) Filed: Dec. 5, 2007

Related U.S. Application Data
(60) Provisional application No. 60/868,593, filed on Dec. 5, 2006.

(51) Int. Cl. B68B 5/00

(52) U.S. Cl. 54/66

(57) ABSTRACT

A pad for use with an animal harness is disclosed. The pad comprises a first side and a second side with a padding material disposed between the first side and the second side. The pad is configured to prevent contact between a shaft, such as a carriage shaft, and an animal, such as a horse.

### CROSS REFERENCE TO RELATED APPLICATIONS

The present Application claims the benefit of and priority as available under 35 U.S.C. § 119 to U.S. Provisional Patent Application 60/868,593, filed Dec. 5, 2006, which is incorporated by reference in its entirety.

### BACKGROUND

This application relates generally to pads used on animal harnesses. In particular, this application relates to pads configured to be used with harnesses for driving horses.

In the sport of combined driving for horses, the horses are required to make very sharp and fast turns during the competition. A problem is encountered where the shafts of the carriage poke the horse in the side while making these turns and the horse is reluctant to perform a maneuver that causes them pain.

The previous solution to this problem has been a large saddle pad that was placed under the harness on the horses back that provided padding. In order to cover the entire area where the shaft travels, it required that the pad be quite large and heavy. One consequence of this was that the horses had to carry the extra weight, and also the large area covered caused the horses to retain more heat during the competition affecting their ability to clear the required vet checks during the competition.

Accordingly, there is a need to prevent horses from experiencing pain or discomfort from contact with carriage shafts when making turns. There is further a need for a device to prevent horses from experiencing pain or discomfort from contact with carriage shafts when making turns while not adding substantial weight. There is yet a further need to prevent horses from experiencing pain or discomfort from contact with carriage shafts when making turns while not increasing the amount of heat retained by the animal.

### SUMMARY

Some embodiments relate to a pad for increasing the comfort of an animal when used with a harness, the pad comprising a first side, a second side coupled to the first side at a periphery of the first and second sides, and a padding material disposed between the first side and the second side. A means for coupling the pad to a harness is also provided.

Other embodiments relate to a harness comprising a pad having a first side, a second side coupled to the first side at a periphery of the first and second sides, a padding material disposed between the first side and the second side, and a means for coupling the pad to a harness.

Yet other embodiments relate to An equestrian pad for use with a harness for driving horses comprising a first side comprising a first material, a second side comprising a second material and coupled to the first side at a periphery of the first and second sides, a padding material disposed between the first side and the second side, and a means for coupling the pad to a harness.

### BRIEF DESCRIPTION OF THE DRAWINGS

FIG. 1 is an elevation view of a pad for use with an animal harness.

FIG. 2 is another elevation view of the pad of FIG. 1.

FIG. 3 is a cross sectional view of the pad of FIG. 2 taken along line 3-3.

FIG. 4 is an elevation view of another embodiment of a pad for use with an animal harness.

FIG. 5 is another elevation view of the pad of FIG. 6.

FIG. 6 is a view of the pad of FIG. 1 in use on an animal harness.

### DETAILED DESCRIPTION

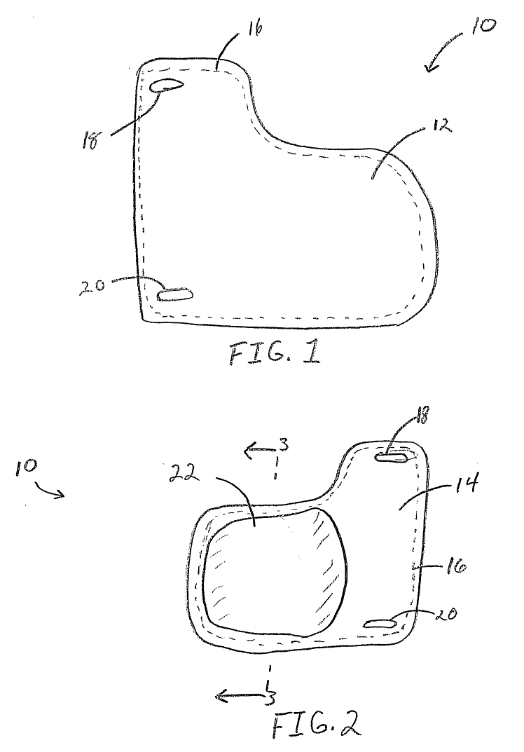

Referring to FIGS. 1 and 2, a pad 10, such as an equestrian pad, includes a first side 12 and a second side 14 that are coupled by, for example, stitching 16 positioned near the periphery of first side 12 and second side 14. Pad 10 is configured for use on the right side of an animal, such as a horse, and a second pad that is the mirror image of pad 10 may be used on the left side of an animal. Pad 10 includes apertures 18 and 20 that are configured to receive a strap for securing pad 10 to a harness strap such as a tug strap or tug loop. Alternatively, pad 10 may be coupled to the harness by buckles, hook and loop devices (such as VELCRO), or other suitable means for coupling the pad to the harness.

Visible from second side 14 is a region 22 that may be bulged relative to the rest of second side 14. Padding material may be positioned within the region 22. In use, first side 12 may be oriented to face outwardly from the animal while second side 14 faces inwardly and may contact the animal. In some embodiments, first side 12 may comprise a relatively flexible but tough material such as a polyurethane, a composite, or other polymeric material. The material used for construction of first side 12 should be strong enough to not wear quickly when repeatedly contacted by a carriage shaft. Second side 14 may be made of a softer material as it will not generally contact a carriage shaft when in use and such softer material may be more comfortable for the animal. In some embodiments, second side 14 may comprise a soft glove leather or a synthetic material.

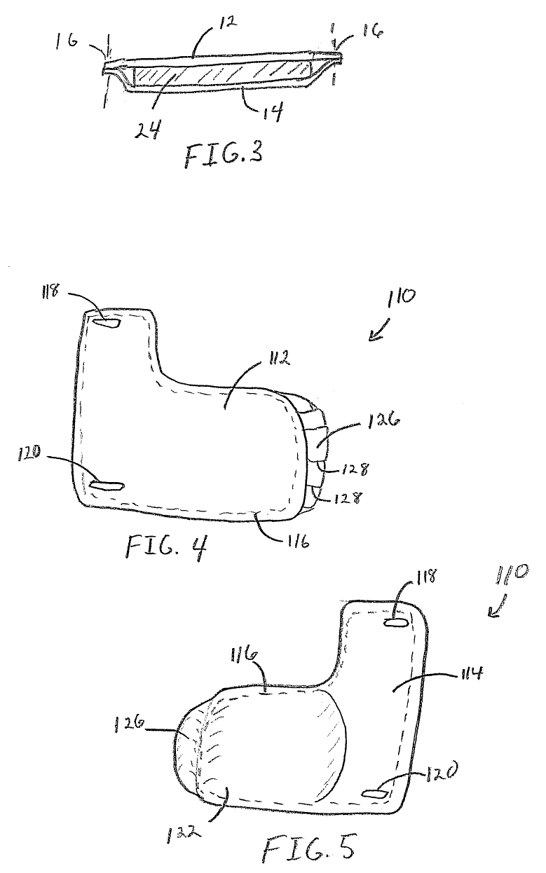

Referring to FIG. 3, the pad 10 comprises first side 12 and second side 14. Positioned between first side 12 and second side 14 is a padding material 24. Padding material 24 may be retained in position by the optional use of an adhesive. First side 12 and second side 14 are coupled to one another by stitching 16. Padding material 24 is also retained in the region between first side 12 and second side 14 by stitching 16. Generally, padding of at least about 0.5 inches thick is sufficient for protecting the animal from detrimental impacts of the carriage shaft.

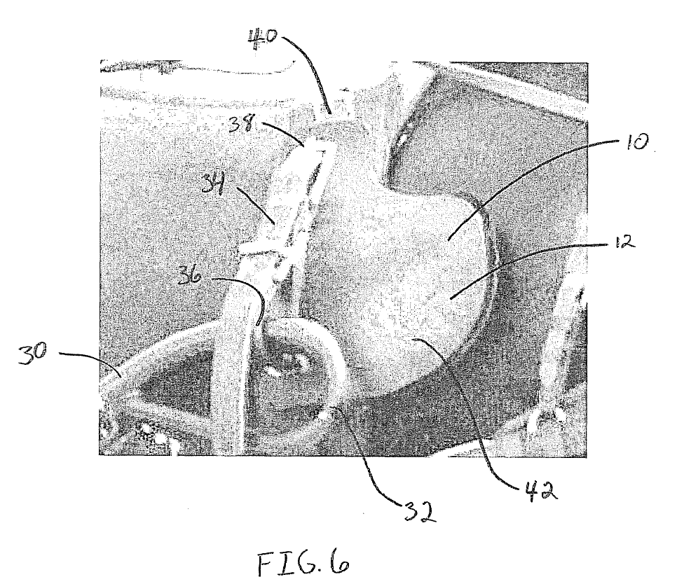

Referring to FIGS. 4 and 5, a pad 110, such as an equestrian pad, includes a first side 112 and a second side 114 that are coupled by, for example, stitching 116. Pad 110 is configured for use on the right side of an animal, such as a horse, and a second pad that is the mirror image of pad 110 may be used on the left side of an animal. Pad 110 includes apertures 118 and 120 that are configured to receive a strap for securing pad 110 to a harness strap such as a tug strap or tug loop. Alternatively, pad 110 may be coupled to the harness by buckles, hook and loop devices (such as VELCRO), or other suitable means for coupling the pad to the harness.

Visible from second side 114 is a region 122 that may be bulged relative to the rest of second side 14. Padding material may be positioned within the region 122. In use, first side 12 may be oriented to face outwardly from the animal while second side 114 faces inwardly and may contact the animal. In some embodiments, first side 112 may comprise a relatively flexible but tough material such as a polyurethane, a composite, or other polymeric material. The material used for construction of first side 112 should be strong enough to not wear quickly when repeatedly contacted by a carriage shaft. Second side 114 may be made of a softer material as it will not generally contact a carriage shaft when in use and such softer material may be more comfortable for the animal. In some embodiments, second side 114 may comprise a soft glove leather or a synthetic material.

A portion of the material comprising second side 114 may be folded over to form extension 126. The material is folded such that stitching 116 passes through the material twice. Folds 128 may be formed to contour the material. Extension 126 provides a pocket for additional padding material. The pocket and padding material prevent the edge of first side 112 proximate to the pocket from contacting the animal when in use.

In other embodiments, first side 12 or 112 and second side 14 or 114 may both be made of synthetic polymeric material. In such embodiments, first side 12 or 112 and second side 14 or 114 may be coupled without the use of stitching, but by other means such as adhesives or ultrasonic welding.

Referring to FIG. 6, a pad 10 is attached to a racing harness for driving horses. Pad 10 is positioned between carriage shaft 30 and the animal (e.g. the horse) and is coupled to the harness by strap 34. Carriage shaft 20 includes a shaft loop 32 that is coupled to the harness by tug loop 36. Strap 36 is secured by a buckle 38 positioned to the outside of pad 10 and buckle 40 positioned to the inside of pad 10. As shown in FIG. 6, a region 42 is shown where loop 32 of carriage shaft 30 contacts

In some embodiments, the pads attach to the tug strap on the harness and therefore move with the shaft as it moves forward and back on the side of the horse. In addition, because they are attached onto the tug strap on the top of the harness saddle, they are held away from the horse when not pressed in by the shaft tip, and therefore they do not cause the horse to build up excessive body heat. They are also much smaller and lighter in weight than the alternative of using heavy blankets.

The pads may comprise either a composite plastic material or leather on the top, and have a bottom layer of soft leather or other similar material next to the horse. There is an area of padding between the two layers and the leather on the bottom wraps around the edge to protect the horse from any sharp impact from the edge of the pad. The lower front corner is made either nearly straight or curved. There is an opening on the top and bottom of the pad to the rear, for the tug strap to go through. To use the shaft shield, the tug loop is removed, the tug strap is slipped through the top hole from back to front, the tug loop rebuckled onto the strap, and the girth buckle down strap inserted through the lower hole in the shaft shield from the front to the back.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention.

Other aspects, objects and advantages of the present invention can be obtained from a study of the drawings, the disclosure and the appended claims.

What is claimed is:

1. A pad for increasing the comfort of an animal when used with a harness, the pad comprising:
a first side;
a second side coupled to the first side at a periphery of the first and second sides;
a padding material disposed between the first side and the second side; and
a means for coupling the pad to a harness.

2. The pad of claim 1, wherein the pad is configured to be positioned between a shaft and an animal when the pad is in use.

3. The pad of claim 2, wherein the means for coupling the pad to the harness comprises a plurality of apertures configured to receive a strap.

4. The pad of claim 3, wherein the strap is a tug loop, and the shaft is a carriage shaft.

5. The pad of claim 1, wherein the first side comprises a polymeric material.

6. The pad of claim 1, wherein the second side comprises a soft leather.

7. A harness for use with an animal comprising the pad of claim 1.

8. The harness of claim 7, wherein the pad is configured to be positioned between a shaft and an animal when the pad is in use.

9. The harness of claim 8, wherein the means for coupling the pad to the harness comprises a plurality of apertures configured to receive a strap.

10. An equestrian pad for use with a harness for driving horses comprising:
a first side comprising a first material;
a second side comprising a second material and coupled to the first side at a periphery of the first and second sides;
a padding material disposed between the first side and the second side; and
a means for coupling the pad to a harness.

11. The pad of claim 10, wherein the pad is configured to be positioned between a shaft and an animal when the pad is in use.

12. The pad of claim 11, wherein the means for coupling the pad to the harness comprises a plurality of apertures configured to receive a strap.

13. The pad of claim 12, wherein the strap is a tug loop, and the shaft is a carriage shaft.

14. The pad of claim 10, wherein the first side comprises a polymeric material.

15. The pad of claim 10, wherein the second side comprises a soft leather.

16. The pad of claim 15, wherein the pad is configured to move with the shaft when the pad is in use.
